(19) United States
(12) Patent Application Publication
(10) Pub. No.: US 2013/0065023 A1
(43) Pub. Date: Mar. 14, 2013

(54) ETCHING HIGH K DIELECTRIC FILMS WITH REDUCED LIKELIHOOD OF DELAMINATION

(71) Applicants: Abbas Ali, Plano, TX (US); Hansley Regan Rampersad, Allen, TX (US)

(72) Inventors: Abbas Ali, Plano, TX (US); Hansley Regan Rampersad, Allen, TX (US)

(73) Assignee: Texas Instruments Incorporated, Dallas, TX (US)

(21) Appl. No.: 13/490,276

(22) Filed: Jun. 6, 2012

Related U.S. Application Data
(60) Provisional application No. 61/532,853, filed on Sep. 9, 2011.

(51) Int. Cl. H01G 4/00; B32B 3/10; B32B 15/04

(52) U.S. Cl. 428/172; 216/6; 428/457

(57) ABSTRACT

A high K dielectric such as PZT, PLZT, and/or BST on a metal-containing conductive layer such as iridium is patterned using a fluorine-free, chlorine-based etchant. Despite the lower etch rate of chlorine-based etchants, the undercut at the dielectric-metal interface associated with fluorine-based etching of the high K dielectric material is avoided, and the likelihood of delamination by the dielectric is reduced. For an integrated circuit capacitive structure, an overlying metal layer is patterned with the high K dielectric using a single etch step.

### CROSS-REFERENCE TO RELATED APPLICATIONS

This application claims priority to U.S. Provisional Patent Application Ser. No. 61/532,853 filed on Sep. 9, 2011. The content of the above-identified patent document is incorporated herein by reference.

### TECHNICAL FIELD

The present application relates generally to etching high K films during integrated circuit fabrication and, more specifically, to avoiding delamination of capacitor electrodes as a result of fluorine etching of PZT, PLZT, and related films.

### BACKGROUND

Materials with a high dielectric constant (K) may be used as a capacitor dielectric within integrated circuits. Examples of such materials that may be used in particular for forming ferroelectric capacitors within a ferroelectric random access memory (FRAM) include lead-based pervoskites such as lead zirconate titanate (PZT) and lanthanum-doped PZT (PLZT, also called lead lanthanum zirconate titanate) and/or barium strontium titanate (BST). Typically, such films are wet etched using hydrofluoric acid or dry etched using one of a variety of fluorine-containing chemistries.

### SUMMARY

Fluorine has been observed by the inventors to etch PZT, PLZT, and related films at relatively higher rates than etching of adjacent metal layers, penetrating into the dielectric film interface with the metal layer. This increases instances of delamination if etch process conditions (i.e., temperature) are not precisely controlled.

In accordance with this disclosure, a high K dielectric (such as PZT, PLZT, and/or BST) on a metal-containing conductive layer (such as iridium) is patterned using a fluorine-free, chlorine-based etchant. Despite the lower etch rate of chlorine-based etchants, the undercut at the dielectric-metal interface associated with fluorine-based etching of the high K dielectric material is avoided, and the likelihood of delamination by the dielectric is reduced. For an integrated circuit capacitive structure, an overlying metal layer is patterned with the high K dielectric using a single etch step.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIGS. 1A through 1C are cross-sectional diagrams illustrating etching of a high K dielectric and conductive layers;

FIG. 2 depicts a portion of a stack etched to form a capacitor structure;

FIG. 3 depicts delamination of a similar capacitor structure;

FIG. 4 depicts a missing upper capacitor electrode and dielectric within an array of capacitor structures; and

FIG. 5 is a high level flow diagram for a process of etching capacitor structures according to one embodiment of the present disclosure.

### DETAILED DESCRIPTION

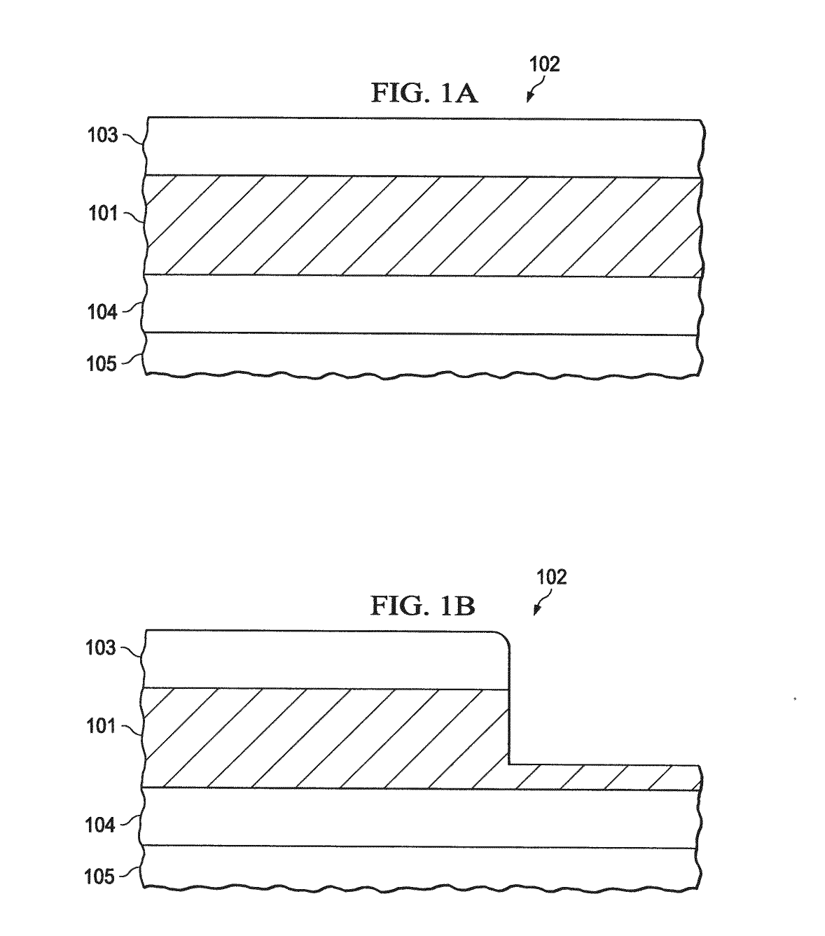

FIGS. 1A through 5, discussed below, and the various embodiments used to describe the principles of the present disclosure in this patent document are by way of illustration only and should not be construed in any way to limit the scope of the disclosure.

Integrated circuit capacitors within FRAMs or other devices may be fabricated with high K (such as approximately 300 or greater) PZT, PLZT or related materials as the capacitor dielectric layer 101, situated in a stack 102 between two iridium (Ir) layers 103-104 used to form the capacitor electrodes as illustrated in FIG. 1A. Although depicted as a single material, the high K dielectric may actually be a heterogeneous structure including multiple layers of different materials (e.g., BST/PZT/BST) and/or doping levels (e.g., titanium-doped PZT). Likewise, either or both of the metal-containing conductive layers 103-104 may be heterogeneous structures comprising more than one metal, metal alloy or semiconductor material.

An array of capacitors may be formed by patterning the stack 102, etching through at least the upper conductive layer 103 and the high K dielectric layer 101 together as shown in FIG. 1B, using an etch masked by a patterned layer (not shown) overlying the upper conductive layer 103. The bottom conductive layer 104 may be etched together with the upper conductive layer 103 and dielectric layer 101 or, alternatively, left substantially un-patterned between adjacent capacitors to form a common electrode for the array.

Fluorine-based (wet or dry) etches exhibit favorable etch rates in patterning of metallic conductor/high K dielectric/metallic conductor stacks such as the stack 102 illustrated in FIGS. 1A and 1B. However, fluorine-based etches have been observed by the inventors to etch the high K dielectric layer 101 at a relatively higher rate than the conductive electrode layers 103-104 for many materials used in commercial fabrication of FRAMs and other integrated circuits including capacitors. As a result, when slightly over-etching past the thickness of the dielectric layer 101, a fluorine-based etch may attack the interface between the dielectric layer 101 and the underlying conductive layer 104, potentially resulting in a slight undercut 106 at the interface as illustrated (not to scale) in FIG. 1C or other etch profile degradation. More significantly, fluorine appears to penetrate the layers at the dielectric-metal interface. A higher likelihood of delamination of the dielectric layer 101 and the upper conductive layer 103 due to interface peeling exists when fluorine-based etches are employed.

Those skilled in the art will recognize that the full structure of an integrated circuit is not illustrated in FIGS. 1A through 1C or described above. Instead, for simplicity and clarity, only so much of an integrated circuit structure as is unique to the present disclosure or necessary for an understanding of the present disclosure is illustrated and described here. The remaining structure of, for instance, a FRAM including the capacitive structure illustrated is known in the art.

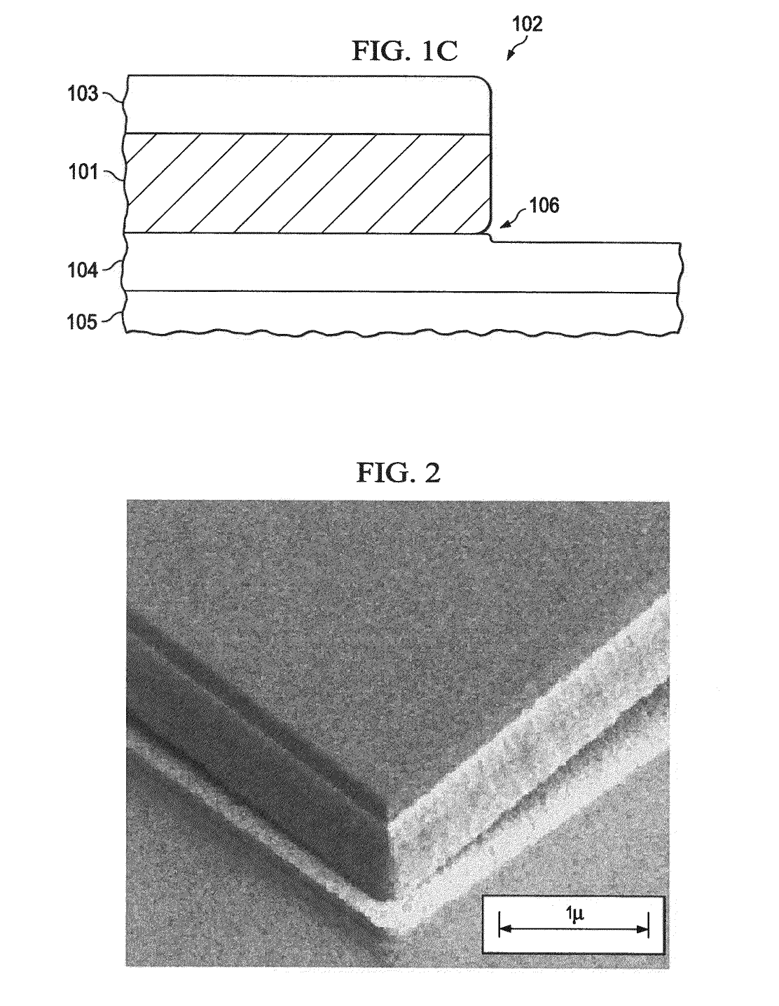

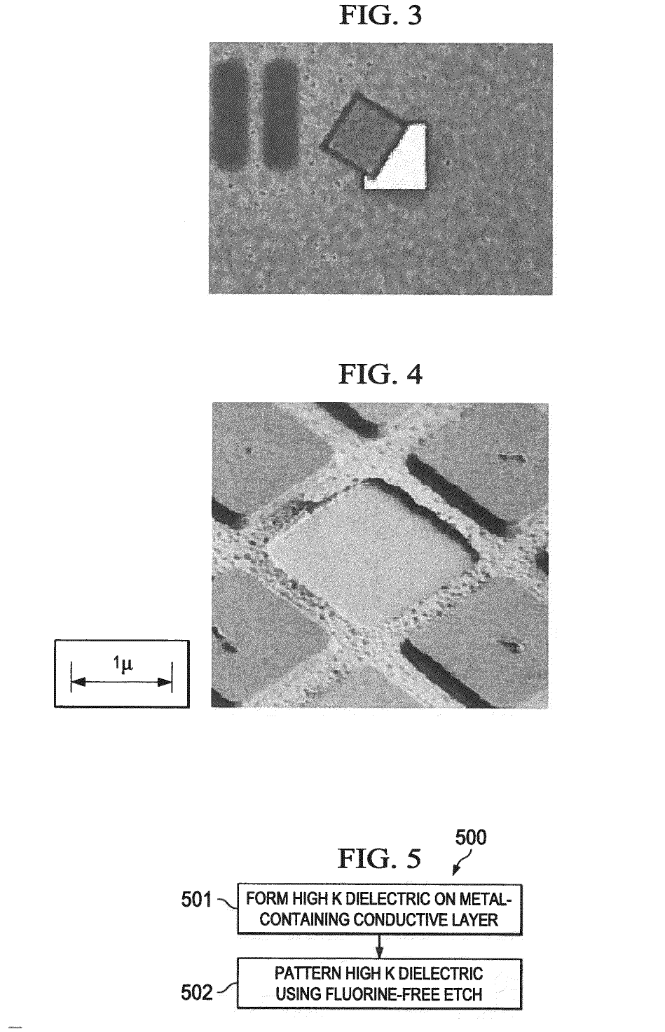

FIG. 2 depicts, from a perspective view, a portion of a stack etched to form a capacitor structure, showing the larger area bottom conductive layer and the jointly patterned dielectric and upper conductive layers similar to the structure illustrated in FIG. 1C. The reference line at the bottom of FIG. 2 is 1 micron (μm) in length. FIG. 3 depicts, from a plan view, delamination of a similar capacitor structure, showing the upper conductive layer delaminating from the bottom electrode. FIG. 4 depicts a missing upper capacitor electrode and dielectric within an array of capacitor structures. The reference line at the bottom of FIG. 4 is 2 microns (2 μm) in length.

FIG. 5 is a high level flow diagram for a process of etching capacitor structures according to one embodiment of the present disclosure. The process 500 depicted is a portion of an overall process for forming an integrated circuit, which includes at least steps before and after the portion shown in FIGURE Sand may include steps in-between the steps shown in FIG. 5. For simplicity and clarity, only the steps of the overall process unique to the present disclosure or necessary for an understanding of the present disclosure are shown.

Process 500 begins with formation of a high K dielectric layer (e.g., dielectric layer 101 in FIGS. 1A and 1B) on a metal-containing conductive layer (e.g., metal layer 104 in FIGS. 1A and 1B) over a substrate (step 501). The high K dielectric layer comprises a material such as PZT, PLZT or BST, for which an etch rate for fluorine-based etching is greater than an etch rate for fluorine-based etching of the metal-containing (e.g., Ir as described above) conductive layer.

At least the high K dielectric layer is then patterned using a fluorine-free, chlorine-based etch (step 502). The same etch may also pattern a metal-containing conductive layer over the high K dielectric layer, such as an overlying Ir layer forming the upper electrode of a capacitor. The etch step may etch partially through the high K dielectric layer or may etch completely through that layer. The etch step may optionally slightly etch the underlying metal-containing conductive layer.

The chlorine-based etches that may be employed to pattern the high K dielectric layer, such as chlorine (Cl₂), boron tri-chloride (BCl₃), or similar gases, have a significantly lower etch rate for PZT, PLZT and/or BST dielectric materials than do fluorine-based etches, and thus are likely to result in less overall throughput for a fabrication process. However, instances of film delamination are reduced with use of chlorine-based etches rather than fluorine-based etches, making the tradeoff in yield worthwhile.

As will be understood by those skilled in the art, the specific parameters (power, time, etc.) for etching the high K dielectric layer will necessarily depend on at least the material of the dielectric layer, the etchant selected, and the thickness of the dielectric layer. Suitable parameters may also depend on, or at least may be selected based upon, the material of the overlying and/or underlying metal-containing layer(s). Solely by way of example, a typical etch step for PZT in a plasma etch tool might involve 2400 Watts (W) of radio frequency (RF) source power, 900 W RF bias power, 140 standard cubic centimeters per minute (sccm) of Argon gas flow, and 60 sccm of BCl₃ gas flow. The duration of the etch step will necessarily depend upon the thickness of the layer(s) being etched.

The following definitions apply to certain words and phrases used throughout this patent document: the term “on” means in direct contact with, while the term “over” encompasses either “on” or separated by one or more intervening materials; the terms “include” and “comprise,” as well as derivatives thereof, mean inclusion without limitation; the term “or,” is inclusive, meaning and/or; and the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for other words and phrases are provided throughout this patent document; those of ordinary skill in the art should understand that in many if not most instances, such definitions apply to prior as well as future uses of such defined words and phrases.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method, comprising:
forming a high dielectric constant dielectric on a metal-containing conductive layer over a substrate, wherein the high dielectric constant dielectric comprises a material for which an etch rate for a fluorine-based etchant is greater than an etch rate for etching of the metal-containing conductive layer with the fluorine-based etchant; and
patterning at least the high dielectric constant dielectric using a fluorine-free, chlorine-based etchant.

2. The method of claim 1, wherein the high dielectric constant dielectric comprises one of lead zirconate titanate (PZT), lead lanthanum zirconate titanate (PLZT), and barium strontium titanate (BST).

3. The method of claim 2, wherein the metal-containing conductive layer comprises iridium.

4. The method of claim 1, further comprising:
forming a second metal-containing conductive layer over the high dielectric constant dielectric; and
patterning the second metal-containing conductive layer and the high dielectric constant dielectric using a single etch step.

5. The method of claim 4, wherein the second metal-containing conductive layer comprises iridium.

6. The method of claim 1, wherein patterning at least the high dielectric constant dielectric further comprises:
etching partially through the high dielectric constant dielectric.

7. The method of claim 1, wherein patterning at least the high dielectric constant dielectric further comprises:
etching completely through the high dielectric constant dielectric.

8. The method of claim 7, wherein patterning at least the high dielectric constant dielectric further comprises:
etching partially through the metal-containing conductive layer.

9. A dielectric structure, comprising:
a high dielectric constant dielectric on a metal-containing conductive layer over a substrate, wherein the high dielectric constant dielectric comprises a material for which an etch rate for a fluorine-based etchant is greater than an etch rate for etching of the metal-containing conductive layer with the fluorine-based etchant, and
wherein an undercut in the high dielectric constant dielectric associated with etching using the fluorine-based etchant and located at an interface between the high dielectric constant dielectric and the metal-containing conductive layer is absent.

10. The structure of claim 9, wherein the high dielectric constant dielectric comprises one of lead zirconate titanate (PZT), lead lanthanum zirconate titanate (PLZT), and barium strontium titanate (BST).

11. The structure of claim 9, wherein the metal-containing conductive layer comprises iridium.

12. The structure of claim 9, further comprising:
a second metal-containing conductive layer over the high dielectric constant dielectric,
wherein the second metal-containing conductive layer is coextensive with the high dielectric constant dielectric.

13. The structure of claim 12, wherein the second metal-containing conductive layer comprises iridium.

14. The structure of claim 9, wherein the high dielectric constant dielectric is etched partially through.

15. The structure of claim 9, wherein the high dielectric constant dielectric is etched completely through.

16. The structure of claim 15, wherein the metal-containing conductive layer is etched partially through.

17. A method, comprising:
forming a high dielectric constant dielectric on a first metal-containing conductive layer over a substrate, wherein the high dielectric constant dielectric comprises one of lead zirconate titanate (PZT), lead lanthanum zirconate titanate (PLZT), and barium strontium titanate (BST) and the first metal-containing conductive layer comprises iridium; and
patterning at least the high dielectric constant dielectric using a fluorine-free, chlorine-based etchant.

18. The method of claim 17, further comprising:
forming a second metal-containing conductive layer over the high dielectric constant dielectric, the second metal-containing conductive layer comprising iridium; and
patterning the second metal-containing conductive layer and the high dielectric constant dielectric using a single etch step.

19. The method of claim 18, further comprising:
etching completely through the high dielectric constant dielectric.

20. The method of claim 19, further comprising:
etching partially through the first metal-containing conductive layer.
